(19) United States
(12) Patent Application Publication
(10) Pub. No.: US 2002/0069410 A1
(43) Pub. Date: Jun. 6, 2002

(54) Control of digital VCR at a remote site using web browser

(76) Inventors: Murthy Atmakuri, Sunnyvale, CA (US); Alexandra Nsonwu, San Jose, CA (US); Seema Kataria, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/728,438

(22) Filed: Dec. 1, 2000

(51) Int. Cl. H04N 5/445; H04N 7/173

(52) U.S. Cl. 725/37; 725/88; 725/133

(57) ABSTRACT

A system and method for controlling a digital device is provided. A user interface is provided with controls the user can select. These controls correspond to controls found on the digital device. When a user selects one of the selectable controls, a control command is sent through a translation process where the control command is translated from a first protocol to a second protocol. The translated command is then sent to the digital device, which executes the control command.

### COPYRIGHT NOTICE

A portion of the disclosure recited in the specification contains material which is subject to copyright protection. Specifically, a Microfiche Appendix in accordance with 37 CFR Section 1.96 is included that lists source code instructions for a process by which the present invention is practiced in a computer system. The Microfiche Appendix comprises 1 sheet of microfiche containing 15 frames, or pages, of source code. The copyright owner has no objection to the facsimile reproduction of the specification as filed in the Patent and Trademark Office. Otherwise all copyright rights are reserved.

### BACKGROUND OF THE INVENTION

The present invention relates to the field of video on demand. More specifically, one embodiment of the invention provides a system for controlling a digital device.

With the advent of the Internet, a plurality of new applications have been developed to leverage the flexibility the Internet provides. As more and more people become connected to the Internet, services that were previously operated locally can now be moved to a remote location. For instance, an individual would have to physically own a VCR where the individual was going to play and watch the home video. However, the Internet has enabled the removal of electronic entertainment devices to remote locations. Therefore, users with access to the Internet can be provided with entertainment services without having the electronic device physically present. The only requirement is access to the Internet. With one device, a user can then access entertainment services from a variety of devices without incurring the expense of buying every device. For example, a user can enjoy movies from a digital VCR or DVD player without owning either device. One application providing this service is video on demand. Users can have instant access to a library of movies, television shows, and videos through the video on demand service. A user can select a title and be provided with the title from a remote consumer entertainment device.

Video on demand presents a user with added flexibility in their viewing choices. Now, a user only needs an Internet enabled device to view a title and does not need to own a consumer entertainment device. However, a user loses some functionality by viewing a title through a remotely operated device. For example, a user cannot pause, stop, fast forward, or rewind the title by pressing a button on the device. Therefore, it is desirable to provide a user with control of the device while leveraging the flexibility of providing entertainment services through the Internet.

### SUMMARY OF THE INVENTION

A system and method for controlling a digital device is provided by virtue of the present invention. In one embodiment of the present invention, a user interface is provided with controls the user can select. These controls correspond to controls found on the digital device. When a user selects one of the controls, a control command is sent through a translation process where the control command is translated from a first protocol to a second protocol. The translated command is then sent to the digital device, which executes the control command.

In another embodiment of the invention, a user is provided with a plurality of selectable items on a user interface. These selectable items correspond to a plurality of digital devices that each contain one of the selectable items. Once a request for the item is received, the digital device that contains the item can provide the item to the user. After being provided with the item, the user can then access the user selectable controls and interact with the system as described above.

A further understanding of the nature and advantages of the invention herein may be realized by reference to the remaining portions of the specification and the attached drawings.

### BRIEF DESCRIPTION OF THE DRAWINGS

FIG. 1 is a diagram of a system for controlling a digital device according to one embodiment of the present invention.

FIG. 2 is a more detailed view of a user interface according to one embodiment of the invention.

### DESCRIPTION OF THE PREFERRED EMBODIMENTS

The present invention relates to a system for providing a user with control of a digital device through a web-enabled device. The user is provided with selectable controls that correspond to controls on the digital device. The user can then access and select the controls. A selected control is then sent through a translation process, which translates the user command from first protocol to a second protocol. The translated command is sent to the digital device, which can execute the user command.

A preferred embodiment of the invention is described in detail computer source code included as Source Code Appendix A to this document. The source code should be consulted for details of the invention.

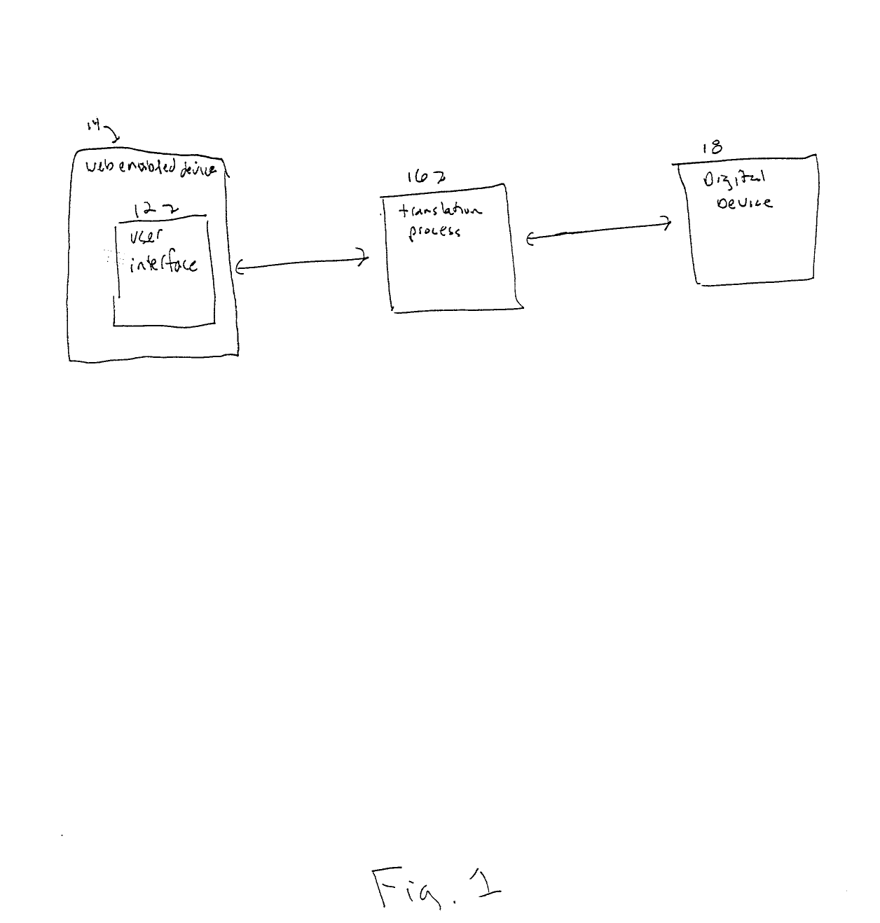

FIG. 1 shows a system for controlling a digital device according to one embodiment of the invention. As shown, user interface 12 interacts or sends commands to a digital device through a translation process 16. User interface 12 can be any interface that can be displayed on a web-enabled device. Preferably, the user interface is developed using HTML (“HyperText Markup Language”) or Javascript. However, it is recognized that any language can be used to develop a user interface. Also, a display screen can be included on the user interface 12. The screen can include user-selectable controls that correspond to discrete controls on a digital device 18. In a specific embodiment, the user interface is contained in a web browser. More specifically, the web browser can be the Emmy web browser from Liberate Technologies.¹ ¹http://www.liberate.com.

The web-enabled device 14 can be any device capable of communicating on the Internet. In a specific embodiment of the invention, possible web-enabled devices can include a personal computer, a set-top box with a television, a cell phone, a portable digital assistant, or any other web-browser enabled device. Basically, any platform that enables access to the Internet and can display web pages can be used.

The web-enabled device can contain a TV tuner card. In one embodiment, the TV tuner card connects to a cable TV outlet or TV antenna and can display live video in the user interface of the web-enabled device. The live video is digitized using video sampling for display on the web-enabled device. In a specific embodiment, WinTV from Hauppage Computer Works, Inc.² can be used. ²http://www.hauppauge.com.

The translation process 16 can be any application that translates a signal from a first protocol to a second protocol. In a specific embodiment, the translation process includes a web server and an interface. An application running on the web server would create HTML or Javascript pages that are sent to the user interface and also receive input from the user in the form of an HTTP (“HyperText Transfer Protocol”) request. The application can also translate the user command to a custom format that can be read by the interface. However, if the interface can read the user command directly from the user interface, then no translation is necessary and the command can just be forwarded to the interface without translation. In a specific embodiment, the interface can be an iLink interface card capable of dispatching AV/C (IEEE 1394)³ commands on a high performance IEEE 1394 bus. However, the interface can be any interface, such as a JINI and USB (“Universal Serial Bus”) interface. Therefore, any device using an interface that can be sent commands from the user interface can be controlled. ³AV/C Tape Recorder/Player Subunit Specification (http://www. 1394ta.org/Download/Technology/Specifications/AVC_TapeRecorderPlayer21.pdf); and V/C Digital Interface Command Set General Specification (http://www.1394ta. org/Download/Technology/Specifications/AVC_{—}30.pdf)

Additionally, the web server can be maintained remotely from the web enabled device or can be embedded within the web-enabled device. Further, the web server and web enabled device can be combined into one device, such as a personal computer, that can perform all the functions of the web server and web-enabled device. Similarly, the interface card can be maintained remotely from the digital device or can be embedded within the device. Further, the digital device and interface card can be combined into one device that can perform all the functions of the interface card and digital device. In other words, the combined web server/web enabled device can be enabled to communicate directly to the combined digital device/interface card.

Digital device 18 can be any digital device that can be controlled by commands outputted by the interface. For example, any digital device compatible with an AV/C, JINI, or USB interface can be used. Additionally, the digital device 18 can be maintained remotely from the user. In a specific embodiment, digital devices can include digital VCRs, DVD (Digital Video Disc) players, or VCB (Video Control Box) players. Additionally, the digital device typically will include control functions such as play, stop, rewind, forward, and pause. These control functions can be represented as discrete controls, such as push buttons, slides, levers, knobs, wheels, or any other discrete controls known in the art. Normally, a user controls the functions of the discrete controls by physically operating the controls of the digital device 18. However, the functions can now be invoked by selecting the corresponding user-selectable controls displayed on the user interface 12.

A method of controlling the digital device according to one embodiment of the invention will now be described. A user can be first provided with a list of items, such as movies, videos, or television shows. The list of items can correspond to a multitude of digital devices that each contain one item in the list, a multitude of digital devices that each contain more than one item in the list, or a single digital device that can contain all the items. For example, a user can be provided with twenty movie choices. The twenty movie choices can each be located on separate digital devices, all of the movie choices can be on one digital device, or there can be less than twenty digital devices that contain the twenty movie choices. One possible scenario can include five devices containing four different movie choices each. The use of multiple digital devices allows a user to select or play more than one item at a time. For example, the user can have as many movies playing at the same time up to the number of digital devices available. In the above example, a user could one, five, or twenty movies playing simultaneously and have control over all of the movies.

Once the user selects an item, an application running on the web server sends a page representing the user interface to the web-enabled device. The page is displayed and contains a window that plays the selected item. Additionally, an “Options” key is provided on the page that displays a hidden window representing an option palette when selected. The option palette contains keys representing functions corresponding to functions of discrete controls on the digital device playing the item. Typical functions include play, stop, rewind, forward, and pause. Once the options key is selected, a timer is also started that will hide the options palette after a certain amount of time. Additionally, the options palette can be hidden if a user selects a key corresponding to an option to hide the option palette.

A user can now control the item playing by using the controls in the option palette. When a control key is selected by the user, a signal is sent to the application. The signal is preferably in an HTTP format but can be in any protocol that represents the underlying control key. The application then translates the signal into a custom format or protocol, which corresponds to a signal that can be understood by an interface to the digital device. Once translated, the signal is then sent to the interface. In a specific embodiment, the signal is sent via a serial communication interface.

When the interface receives the signal, the interface reads the command and sends the appropriate command to the digital device. In a specific embodiment, the commands sent to the digital device are AV/C commands as represented by IEEE standard 1394. Additionally, the interface can send the signal via an iLink bus or IEEE standard 1394 high performance bus.

Once the digital device receives the command, the command is executed by the device. The appropriate output is shown on the user interface after the command is executed. For example, a user could be watching a movie and decide to pause the movie. Once the pause button is selected on the user interface, a pause signal will be sent to the appropriate digital device and the movie playing on the user interface would be paused.

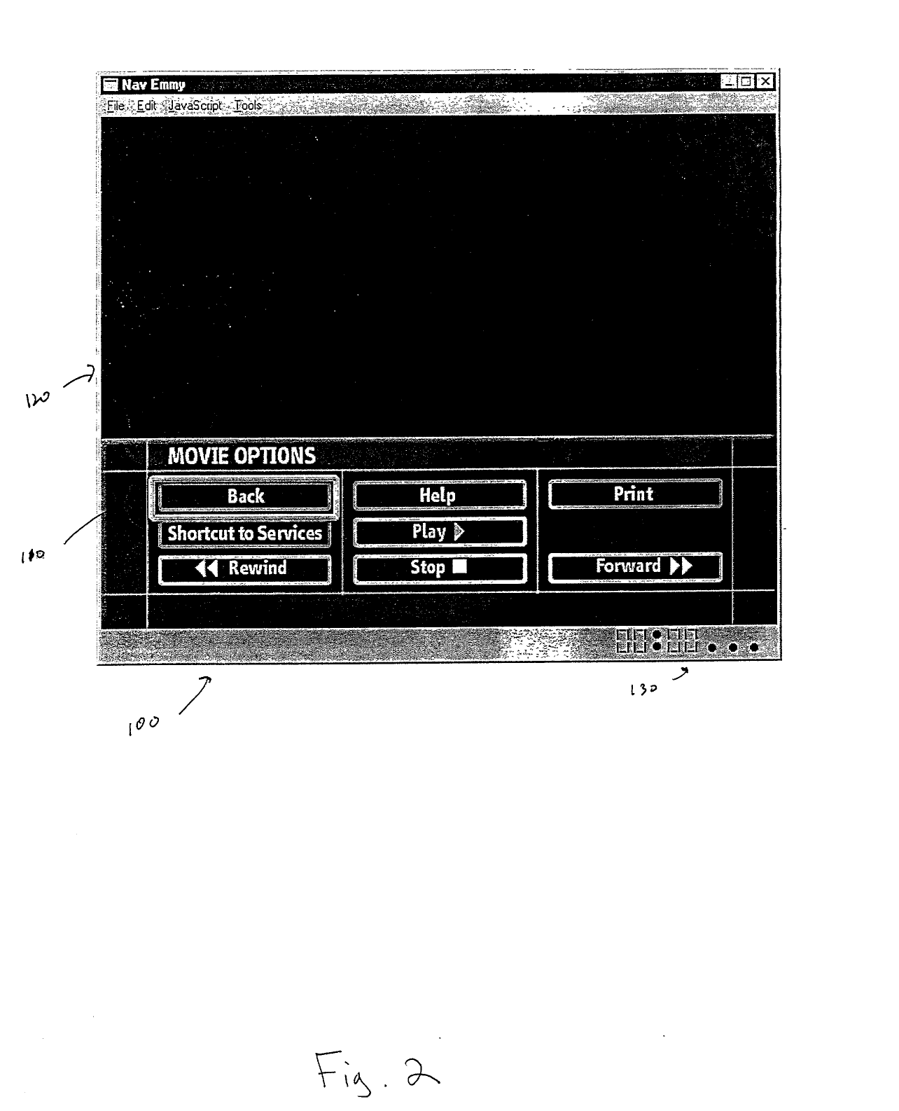

FIG. 2 shows a possible implementation or example of the user interface. As shown, interface 100 contains option palette 110, which represents discrete controls on the digital device. Once invoked, a user can select one of the buttons to control the digital device. The selected movie is shown on display screen 120; however, no movie is represented on display screen 120 in the figure. The user interface also contains a timer 130 that corresponds to the elapsed time in the present movie.

The user interface can be created using any web-based language. In a specific embodiment, hypertext marked-up language (“HTML”) or Java script can be used to create the pages. The HTML or Java script pages are also preferably created by a C++and/or CGI application but can be created by any compatible language. Additionally, the application can be run on a remote web server or be run by the web-enabled device.

Certain features of the software will now be described. As in any web-based application, different files will be running on the client as well as the server. The following files are preferably run on the client's side: Vod_final.htm, Option vod.htm, Vod_options.js, and Global.js. Additionally, the Serial.cpp application is preferably run on the server side. It should be noted that the files are not restricted to running on just the client side or the server side and can be implemented on either the client side or server side.

A method according to one embodiment of the invention illustrating the interaction of different files is hereinafter described. When the user chooses a video on demand movie, television show, or video, the Vod_final.htm file is launched. This file creates a hidden window for the option palette using the Option_vod.htm file. If the user decides to select the “Options” key on the user interface, then the option palette is made visible. While the Option_vod.htm file is loading, the file is redirected to the Serial.cpp file to load the correct option palette. Once the Option Palette is invoked, the Vod_options.js file defines the various functions that are used to control the option palette. When the user selects a user command from the option palette, the Serial.cpp application sends the appropriate command to the digital device.

Key features in the attached source code files referenced in Appendix A will now be described. Referring to the Vod_final.htm file, line 79 represents the main entry point. The <BODY> tag specifies the handlers for different tasks. As shown, the background for the page is a TV object tuned to channel 3. This is shown by the section “background=‘TV:3’”. Additionally, the code section “onload=‘Vod_Init( )’” represents invoking the function Vod-Init( ) after the page is rendered on the screen. The keyboard input handler is specified as Vod_HandleKeyDown( ).

Line 5 in the file represents additional functions that are included using the Global.js file. On line 13, the function Vod-Init( ) creates the option palette window with the URL set to the Option-vod.htm file. On line 40, the ShowPalette( ) function is used to show or hide the option palette.

Referring now to the Option_vod.htm file, an HTML page that sends the initial command to the digital device is created. On line 12, the page is loaded and redirected to a new URL that will issue the play command to the digital device. The page then navigates to the URL, which executes the program “serial. exe” that requests the play command.

The Vod-options.js file contains various functions that are used to control the digital device. Line 3 represents the update_vod_palette( ) function that sets the images for the control buttons. A timer is also started that will cause the option palette to hide after a period of time. Line 13 represents the OnRewind( ) function that is invoked when the user selects the “rewind” key. This function sends out the “Rew” command to the server application (serial.exe). Line 17 represents the OnPlay( ) function that is invoked when the user selects the “play” key. This function sends out the “play” command to the server application (serial.exe). Line 21 represents the OnForward( ) function that is invoked when the user selects the “forward” key. This function sends out the “ff” command to the server application (serial.exe). Line 25 represents the OnStop( ) function that is invoked when the user selects the “stop” key. This function sends out the “stop” command to the server application (serial.exe). Line 39 represents the buttons function that is invoked when a user selects any of the control buttons. Finally, line 85 represents the StartTimer( ) function. This function determines the amount of time before the option palette is hidden.

The file Serial.cpp file is a CGI application that is invoked whenever a web server receives a request from the client. The application uses a serial port on the web server to connect to an iLink Board. The application also sends the user commands to the iLink interface.

On line 37, the WriteCommand( ) formats the user's commands and writes them through a serial port to the iLink Board. On line 77, the InitComm( ) function establishes a serial connection to the iLink Board for sending the user commands. The getcgivars( ) function on line 149 then forwards the client's user commands.

The main entry point of the CGI application is presented on line 258. The int_tmain( ) function defines the bulk of the application. The user requests are obtained using getcgivars( ). Then, the serial communication is initialized using InitComm( ). Next, the commands are written to the digital device using WriteCommand( ). HTML is then sent back to the user using SendOutHTML( ). In the HTML that is sent back to the user, the VOD control functions are included using the Vod_options.js on line 334. When the client receives the HTML, the screen is updated by invoking update-vod_palette( ) as defined in Vod_options.js. Additionally, line 351 represents the button( ) handler that defines the control buttons table in the option palette. Line 399 represents the SendOutHTML( ) function that returns the HTML to the user after sending the user command to the digital device.

Referring to the Global.js file, line 44 represents the ShowPalette( ) function that is invoked whenever a user selects a designated options button while watching the movie, television show, or video. In this case the function shows the option palette.

In one embodiment, the present invention is implemented using computer software. Computer programming languages such as C, C++, CGI, as well as many others can be used for such implementation.

The above description is illustrated and not restrictive. Many variations of the invention will become apparent to those skilled in the art upon review of this disclosure. The scope of the invention should, therefore, be examined not with reference to the above description but instead should be determined with reference to the pending claims along with their full scope or equivalence.

### APPENDIX A

[image]

[image]

[image]

[image]

[image]

[image]

[image]

[image]

[image]

[image]

[image]

[image]

[image]

[image]

[image]

What is claimed is:

1. A system for controlling a digital device having discrete controls, the system comprising:
a user interface including a display screen, the user interface including user-selectable controls displayed on the display screen, wherein the user-selectable controls correspond to the discrete controls on the digital device; and
a translation process, wherein the translation process translates a user control command from the user interface from a first protocol to a second protocol,
wherein the digital device comprises logic to receive the user control command in the second protocol and execute the user control command.

2. The system of claim 1, wherein the user selectable controls include play, stop, rewind, forward, and pause functions.

3. The system of claim 1, wherein the first protocol includes HTTP.

4. The system of claim 1, wherein the second protocol includes AV/C.

5. The system of claim 1, wherein the second protocol includes JINI.

6. The system of claim 1, wherein the second protocol includes USB.

7. The system of claim 1, wherein the translation process comprises:
a web server comprising logic to translate the user control command; and
an interface to the digital device comprising logic to receive the translated user command and forward a corresponding user command.

8. The system of claim 7, wherein the interface to the digital device includes an iLink interface.

9. The system of claim 1, wherein the digital device includes a digital VCR, digital video disc (DVD) player, and video control box (VCB) player.

10. A method for controlling a digital device comprising the steps of:
providing a user with user selectable controls, wherein the user-selectable controls correspond to controls on the digital device;
receiving a command from the user-selectable controls;
translating the command from a first protocol to a second protocol;
sending the translated command to the digital device; and
executing the command at the digital device.

11. The method of claim 10, wherein the command includes play, stop, rewind, forward, and pause functions.

12. The method of claim 10, wherein the first protocol includes HTTP.

13. The method of claim 10, wherein the second protocol includes AV/C.

14. The method of claim 10, wherein the digital device includes a digital VCR, digital video disc (DVD) player, and video control box (VCB) player.

15. A method for controlling a digital device comprising the steps of:
providing a user with a plurality of selectable items on a user interface;
generating a request for an item from the selectable items;
providing the item to the user;
providing the user with user selectable controls, wherein the user-selectable controls correspond to controls on the digital device;
receiving a command from the user-selectable controls;
translating the command from a first protocol to a second protocol;
sending the translated command to the digital device; and
executing the command at the digital device.

16. The method of claim 15, wherein the plurality of selectable items correspond to a plurality of digital devices.

17. The method of claim 15, wherein the command includes play, stop, rewind, forward, and pause functions.

18. The method of claim 15, wherein the first protocol includes HTTP.

19. The method of claim 15, wherein the second protocol includes AV/C, JINI, or USB.

20. The method of claim 15, wherein the digital device includes a digital VCR, digital video disc (DVD) player, and video control box (VCB) player.

21. A method for controlling a digital device comprising the steps of:
providing a user with user selectable controls, wherein the user-selectable controls correspond to controls on the digital device;
receiving a command from the user-selectable controls;
translating the command from an HTTP format to an AV/C format;
sending the AV/C command to the digital device; and
executing the command at the digital device.

22. The method of claim 21, wherein the command includes play, stop, rewind, forward, and pause functions.

23. The method of claim 21, wherein the digital device includes a digital VCR, digital video disc (DVD) player, and video control box (VCB) player.

24. A system for controlling a digital device comprising:
a user interface including user selectable controls, wherein the user-selectable controls correspond to controls on the digital device;
a web server comprising logic to translate an HTTP request; and
an interface to the digital device comprising logic to receive the translated HTTP request and forward a corresponding AV/C command,
wherein the digital device comprises logic to receive the AV/C command and execute the AV/C command.

25. The system of claim 24, wherein the user selectable controls include play, stop, rewind, forward, and pause functions.

26. The system of claim 24, wherein the interface to the digital device includes an iLink interface card.

27. The system of claim 24, wherein the digital device includes a digital VCR, digital video disc (DVD) player, and video control box (VCB) player.
